(19) United States
(12) Patent Application Publication
(10) Pub. No.: US 2026/0289892 A1
(43) Pub. Date: Sep. 24, 2026

(54) RENDERING WITH ADAPTIVE VARIABLE RATE SHADING

(71) Applicant: Advanced Micro Devices, Inc., Santa Clara, CA (US)

(72) Inventors: GuoYou Wang, Shanghai (CN); Donghui Sheng, Shanghai (CN)

(73) Assignee: Advanced Micro Devices, Inc., Santa Clara, CA (US)

(21) Appl. No.: 19/083,488

(22) Filed: Mar. 19, 2025

(51) Int. Cl. G06T 15/00; G06T 1/20

(52) U.S. Cl. CPC G06T 15/005; G06T 1/20; G06T 2200/24

(57) ABSTRACT

Systems, methods, and devices for rendering an image. A model of a three-dimensional (3D) object is rendered to generate a two-dimensional (2D) image. A shading rate of the rendering is based on GPU occupancy and user interaction. In some implementations, the GPU occupancy and user interaction comprise GPU occupancy and user interaction during rendering of a prior frame. In some implementations, the GPU occupancy and user interaction comprise GPU occupancy and user interaction during rendering of an immediately preceding frame. In some implementations, the GPU occupancy and user interaction comprise GPU occupancy and user interaction during rendering of a plurality of prior frames. In some implementations, the GPU occupancy and user interaction comprise average GPU occupancy and average user interaction over rendering of a plurality of prior frames.

### BACKGROUND

Software for design of 3D images, such as 3D design software or computer aided design (CAD) software, typically render a 3D model for display on a 2D screen during operation. For example, an underlying 3D model of an object is rendered to display a 2D view of the object from a particular perspective.

As part of the rendering process, a pixel shader calculates output values for 2D pixels based on the 3D model. Typically, pixel shader operations each impact one or more visual properties (e.g., color) of a single pixel in the rendered 2D image.

Variable Rate Shading (VRS) or Variable Shading (VS) specifies a number of pixels that are affected by a single shader operation (e.g., in a certain region of a frame). For example, a 1×1 shading rate indicates that each shader operation impacts one pixel, whereas a 2×2 shading rate indicates that each shader operation impacts four pixels, arranged in a square, a 1×4 shading rate indicates that each shader operation impacts four pixels arranged in a column, and a 4×1 shading rate indicates that each shader operation impacts four pixels arranged in a row. Accordingly, in some cases a single shader operation at a 2×2 shading rate calculates the color for all four pixels in a 2×2 square, and all four of these pixels will have the same color.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating a graphics processing pipeline, according to an example; and

FIG. 4 is a flowchart illustrating an example procedure for setting and/or adjusting shading rate;

FIG. 5 is a flowchart illustrating another example procedure for setting and/or adjusting shading rate;

FIG. 6 is a flowchart illustrating an example procedure for calculating GPU occupancy;

FIG. 7 is a block diagram illustrating example command buffers and timestamps for GPU occupancy calculation; and

FIG. 8 is a block diagram illustrating another example method for calculating a variable shading rate.

### DETAILED DESCRIPTION

Under some circumstances, such as where the 3D model is manipulated (e.g., rotated to show a new perspective, panned, zoomed, or otherwise changed in real time), the 2D image is re-rendered, causing a load on the processor (e.g., GPU). Depending on the performance capabilities of the GPU and/or rendering software, it may not be possible to render the 2D image in real time (e.g., in time with the user's manipulation of the model) under the load, and changes to the image on the 2D screen may lag the changes input to the model (e.g., user inputs to rotate the model), potentially degrading user experience.

One potential solution to such lag is to reduce the resolution of the display during model manipulation, rotation, panning, zooming and/or etc., however such reduced resolution may reduce quality, which also potentially degrades user experience. In such cases, quality (e.g., in terms of resolution)is sacrificed to maintain performance (e.g., in terms of frame rate).

Accordingly, it may be desired to provide methods, devices, and/or systems where shading rate is adjusted based on GPU occupancy, user interaction, and/or a combination of GPU occupancy and/or user interaction. In some implementations, this provides the advantage of enhancing performance (e.g., in terms of frame rate) by lowering the shading rate from a native shading rate if the user is manipulating the model while the GPU is busy (e.g., has an occupancy above a threshold amount), and preserving quality (e.g., in terms of resolution, shading, etc.) by maintaining the native shading rate in cases where the user is manipulating the model while the GPU is not busy (e.g., has an occupancy below the threshold amount), or is not manipulating the model. In some implementations, the shading rate is adjusted dynamically based on whether the user is interacting with the model (or an amount by which the user is interacting with the model, e.g., in terms of movement rate) and/or whether the GPU is busy (or an amount by which the GPU is busy, e.g., in terms of GPU occupancy threshold). In some implementations, GPU occupancy is an indication of how busy the GPU is. In some implementations, GPU occupancy (or GPU usage) is expressed as a percentage of the GPU that is in use, or a percentage of time that the GPU is in use. For example, in some implementations, if the GPU is fully busy, GPU occupancy is 100%, whereas if only half of the computing resources of the GPU are busy (e.g., half of a number of single-instruction-multiple-data (SIMD) units on the GPU are busy, and half are idle), GPU occupancy is 50%, or if the GPU is fully busy for only half of the time during a reference period of time, the GPU occupancy is 50%.

Some implementations provide a method for rendering an image. A model of a three-dimensional (3D) object is rendered to generate a two-dimensional (2D) image. A shading rate of the rendering is based on GPU occupancy and user interaction.

In some implementations, the GPU occupancy and user interaction comprise GPU occupancy and user interaction during rendering of a prior frame. In some implementations, the GPU occupancy and user interaction comprise GPU occupancy and user interaction during rendering of an immediately preceding frame. In some implementations, the GPU occupancy and user interaction comprise GPU occupancy and user interaction during rendering of a plurality of prior frames. In some implementations, the GPU occupancy and user interaction comprise average GPU occupancy and average user interaction over rendering of a plurality of prior frames.

In some implementations, the user interaction comprises rotating, panning, or zooming the 3D model or 2D image. In some implementations, the user interaction comprises a mouse manipulation or button press. In some implementations, the GPU occupancy comprises occupancy of a graphics processing unit (GPU), occupancy of a plurality of GPUs, occupancy of a GPU core and/or occupancy of a plurality of GPU cores. In some implementations, the GPU occupancy comprises an idle time or busy time of a GPU, during the rendering. In some implementations, the GPU occupancy is calculated based on a start time of execution of a render command buffer and an end time of the execution of the render command buffer.

Some implementations provide a processor. The processor includes circuitry configured to render a model of a three-dimensional (3D) object to generate a two-dimensional (2D) image. A shading rate of the rendering is based on GPU occupancy and user interaction.

In some implementations, the GPU occupancy and user interaction comprise GPU occupancy and user interaction during rendering of a prior frame. In some implementations, the GPU occupancy and user interaction comprise GPU occupancy and user interaction during rendering of an immediately preceding frame. In some implementations, the GPU occupancy and user interaction comprise GPU occupancy and user interaction during rendering of a plurality of prior frames. In some implementations, the GPU occupancy and user interaction comprise average GPU occupancy and average user interaction over rendering of a plurality of prior frames.

In some implementations, the user interaction comprises rotating, panning, or zooming the 3D model or 2D image. In some implementations, the user interaction comprises a mouse manipulation or button press. In some implementations, the GPU occupancy comprises occupancy of a graphics processing unit (GPU), occupancy of a plurality of GPUs, occupancy of a GPU core, and/or occupancy of a plurality of GPU cores. In some implementations, the GPU occupancy comprises an idle time or busy time of a processor, during the rendering. In some implementations, the GPU occupancy is calculated based on a start time of a render command buffer and an end time of the render command buffer.

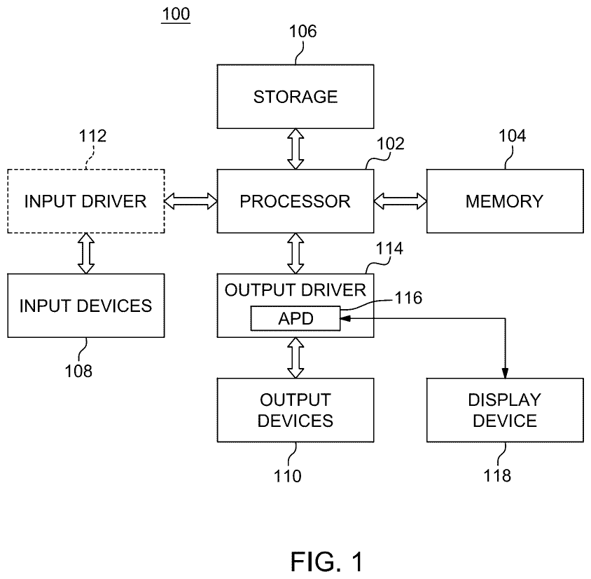

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

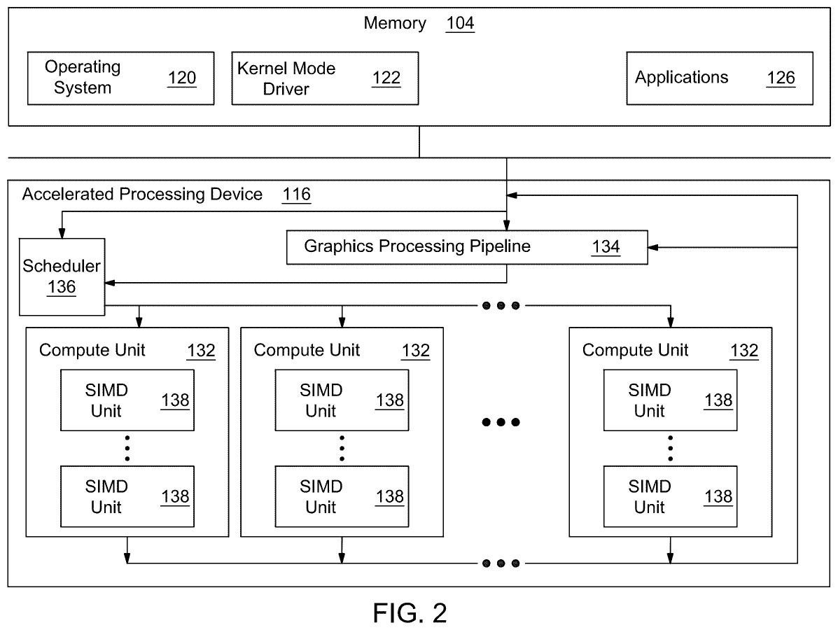

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with or using different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

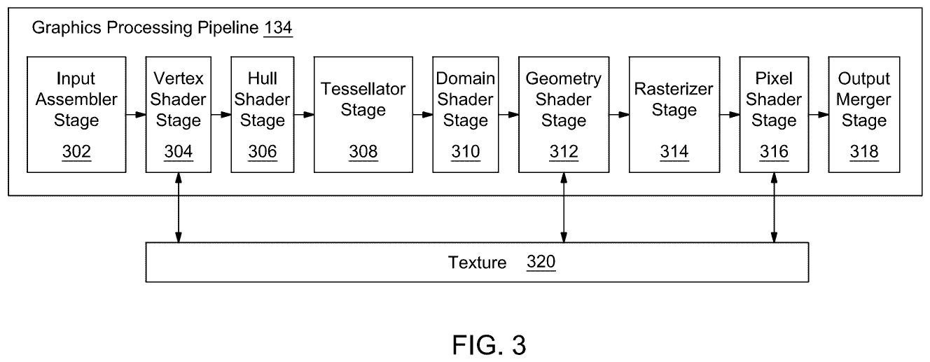

FIG. 3 is a block diagram showing additional details of the graphics processing pipeline 134 illustrated in FIG. 2. The graphics processing pipeline 134 includes logical stages that each performs specific functionality. The stages represent subdivisions of functionality of the graphics processing pipeline 134. Each stage is implemented partially or fully as shader programs executing in the programmable processing units 202, or partially or fully as fixed-function, non-programmable hardware external to the programmable processing units 202.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the programmable processing units 202.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the programmable processing units 202 perform operations for the geometry shader stage 312.

The rasterizer stage 314 accepts and rasterizes simple primitives and generated upstream. Rasterization includes determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the programmable processing units 202.

The output merger stage 318 accepts output from the pixel shader stage 316 and merges those outputs, performing operations such as z-testing and alpha blending to determine the final color for a screen pixel.

Texture data, which defines textures, are stored and/or accessed by the texture unit 320. Textures are bitmap images that are used at various points in the graphics processing pipeline 134. For example, in some instances, the pixel shader stage 316 applies textures to pixels to improve apparent rendering complexity (e.g., to provide a more “photorealistic” look) without increasing the number of vertices to be rendered.

In some instances, the vertex shader stage 304 uses texture data from the texture unit 320 to modify primitives to increase complexity, by, for example, creating or modifying vertices for improved aesthetics. In one example, the vertex shader stage 304 uses a height map stored in the texture unit 320 to modify displacement of vertices. This type of technique can be used, for example, to generate more realistic looking water as compared with textures only being used in the pixel shader stage 316, by modifying the position and number of vertices used to render the water. In some instances, the geometry shader stage 312 accesses texture data from the texture unit 320.

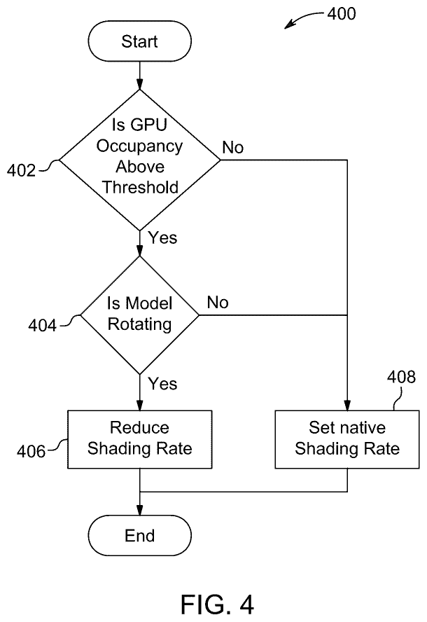

FIG. 4 is a flowchart illustrating an example procedure 400 for setting and/or adjusting shading rate. Procedure 400 is implementable with any suitable hardware and/or software, such as shown and described with respect to FIGS. 1, 2, and/or 3. In procedure 400, shading rate is adjusted based on whether a user is manipulating a 3D model and/or whether a GPU is busy (e.g., has an occupancy above a threshold amount). In some implementations, this provides the advantage of enhancing performance (e.g., in terms of frame rate) by lowering the shading rate if the user is manipulating the model while the GPU is busy (e.g., has an occupancy above a threshold amount), and preserving quality (e.g., in terms of resolution, shading, etc.) by maintaining the native shading rate in cases where the user is manipulating the model while the GPU is not busy (e.g., has an occupancy below the threshold amount), or is not manipulating the model. In some implementations, the shading rate is adjusted dynamically based on whether the user is interacting with the model (or an amount by which the user is interacting with the model, e.g., in terms of movement rate) and/or whether the GPU is busy (or an amount by which the GPU is busy, e.g., in terms of GPU occupancy threshold).

In procedure 400, 3D model rotation is used as an example of user interaction upon which the shading rate is adjusted, however this is exemplary. In some implementations, rotation or other manipulation of a 3D model is effected by a user via one or more input devices 108 (e.g., a mouse movement). In some implementations, the shading rate is adjusted based on mouse movement (e.g., as a proxy for rotation or other model manipulation).

On condition 402 that the GPU is busy (e.g., above a threshold occupancy), and condition 404 that the 3D model is under rotation (e.g., rotating, being rotated, and/or being commanded to rotate) the shading rate is reduced at 406. Otherwise, on condition 402 that the GPU is not busy, or on condition 404 that the model is not under rotation, the shading rate is set to a native shading rate (e.g., 1×1) at 408. It is noted 3D model rotation is an example condition, and that other conditions (e.g., model panning or zooming, etc.) are useable as alternative or additional conditions in some implementations.

In some implementations, whether the GPU is considered busy, for purposes of setting and/or adjusting the shading rate, is determined on a frame-by-frame basis (e.g., the determination is made for each frame or a group of frames, and/or on the basis of each frame or group of frames). In some implementations, the determination of whether the GPU is considered busy is determined for one frame and applied to a subsequent frame (e.g., to the next frame).

In some implementations, whether the GPU (or other processor) is considered busy, for purposes of setting and/or adjusting the shading rate, is based on GPU occupancy and/or GPU idle time. For example, in some implementations, the GPU is considered busy, for purposes of setting and/or adjusting the shading rate, if the GPU occupancy is above a threshold GPU occupancy,

In some implementations, whether the model is considered to be under rotation for purposes of setting and/or adjusting the shading rate is determined on a pixel-by-pixel basis (e.g., the determination is made for each pixel or a group of pixels, and/or on the basis of each pixel and/or a group of pixels), and/or frame-by-frame basis (e.g., the determination is made for each frame or a group of frames, and/or on the basis of each frame or group of frames). In some implementations, the determination of whether the model is considered to be under rotation is determined for one pixel and/or frame and applied to a subsequent pixel and/or frame (e.g., to the next pixel and/or next frame).

In some implementations, the determination is made on another basis, such as on a command buffer basis.

In some implementations, the model is considered to be under rotation (or other manipulation), for purposes of setting and/or adjusting the shading rate, if it is currently rotating, being rotated, or being commanded to rotate (e.g., via mouse movement and/or button press).

In some implementations, the shading rate is reduced by setting the shading rate to any suitable shading rate (e.g., a shading rate lower than the current shading rate, or than a native shading rate). For example, in some implementations, the shading rate is reduced by setting the shading rate to a preset shading rate (e.g., which is lower than a native shading rate). In some implementations, the shading rate is reduced by setting the shading rate based on any suitable factor, or combination of factors. For example, in some implementations, the shading rate is reduced by setting the shading rate to a shading rate that is based on whether the GPU is busy, how busy the GPU is (e.g., in terms of percentage of idle time within a time window), whether the model is rotating, a speed of rotation of the model, whether the speed of rotation is increasing or decreasing, a rate of increase or decrease in speed, and/or any other suitable factors (e.g., based whether the model is under a panning operation and/or zooming operation, and/or based on panning speed and/or zooming speed, etc.).

In some implementations, the native shading rate is preset, or is based on a shading rate set at a prior time (e.g., in a prior frame, such as the immediately preceding claim). For example, in some implementations, a shading rate that is set to a reduced shading rate is the native shading rate for the next frame.

It is noted that procedure 400 is exemplary, and that variations are used in other implementations. For example, in some other implementations, the shading rate is adjusted based on either a processor (e.g., GPU) busy state (e.g., whether the processor is rendering, and/or a percentage or ratio of time that the processor is performing rendering tasks) or a model manipulation (e.g., rotation) state (e.g., whether the model is being manipulated and/or a speed or rate at which the model is being manipulated), or the model manipulation condition may be determined before or simultaneously with determination of the processor busy state. In some other implementations, the shading rate is increased based on a reduction in processor busy state or model manipulation rate.

In some implementations, adjusting the shading rate based on whether a processor is busy (e.g., based on a GPU occupancy) and/or based on whether the user is interacting with the model or rendering (e.g., rotation), can provide the advantage of facilitating improved performance when desired and/or needed, or maintaining quality when desired and/or needed.

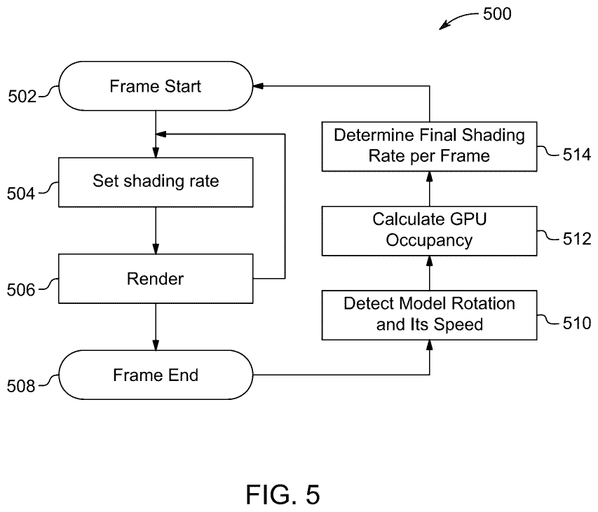

FIG. 5 is a flowchart illustrating another example procedure 500 for setting and/or adjusting shading rate per-frame.

In procedure 500, rendering of a frame begins at 502. The shading rate for the first frame is set at 504 and rendering occurs at 506 for a first frame. For the first frame, in some implementations, the shading rate is set to a native shading rate (e.g., 1×1), or is set to a shading rate based on a prior frame. This shading rate is set at 504 for each render 506, e.g., if several rendering passes occur for the frame, as shown by the arrow from 506. For subsequent frames, in some implementations, the shading rate is set based on rendering of the prior frame (e.g., based on whether the model is being manipulated during rendering of the prior frame and/or whether the GPU occupancy is above a threshold during rendering of the prior frame).

After rendering of the frame is complete at 508, the per-frame shading rate is determined. At 510, whether the model is rotating and/or the speed of rotation of the model (or other manipulations, such as zooming or panning, etc.) is detected at 510. GPU usage (e.g., whether the GPU occupancy is above a threshold) is detected at 512. Based on the model rotation detected at 510 and GPU usage detected at 512, a per-frame shading rate is determined at 514, and is used as the rendering shading rate for the next frame at 502.

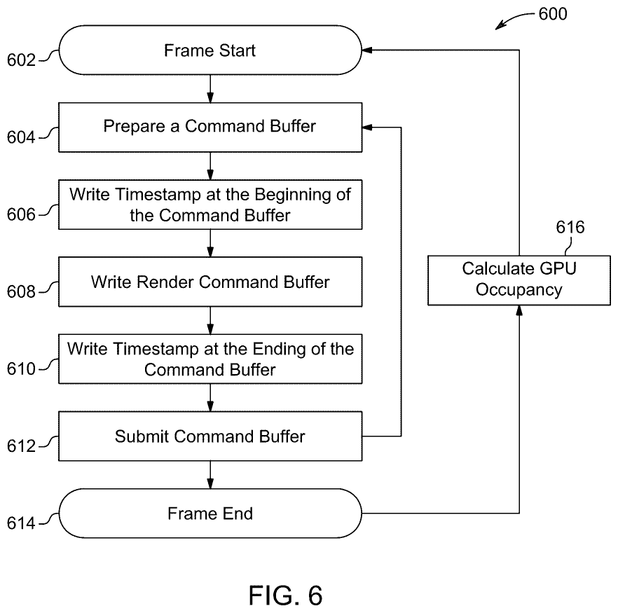

FIG. 6 is a flowchart illustrating an example procedure 600 for calculating GPU occupancy. It is noted that procedure 600 is exemplary, and that GPU (or other processor) usage may be calculated in different ways in other implementations.

In procedure 600, rendering of a frame begins at 602. A command buffer is prepared at 604. In some implementations, a command buffer is binary stream which can be executed by GPU. In some implementations, the GPU executes command buffers one-by-one. In some implementations, each command buffer includes one or more render operations, an instruction to write a beginning timestamp, and an instruction to write an ending timestamp.

An instruction to write a timestamp to memory is inserted at the beginning of the command buffer at 606. In some implementations, the timestamp indicates GPU time. In some implementations, the timestamp is written to a specified video memory.

A render command buffer is written at 608. In some implementations, the render command buffer is a byte stream which is executable by the GPU. In some implementations, writing the command buffer includes producing the byte stream for execution by the GPU.

Another instruction to write a timestamp to memory is inserted at the ending of the command buffer at 610. In some implementations, the timestamp indicates GPU time. In some implementations, the timestamp is written to a specified video memory.

The command buffer is submitted at 612. In some implementations, if the command buffer is full or if an application wants to submit all current render operations, a GPU driver sends the command buffer (e.g., binary stream) to the GPU for execution. The timestamp instructions inserted at the beginning of the command buffer at 606 and at the ending of the command buffer at 610 write time stamps to a suitable memory location (e.g., in video memory). In some implementations, these timestamps are usable to determine GPU occupancy during rendering of the frame.

After all desired command buffers for a frame have been executed by the GPU (and the corresponding timestamps have been written to memory)rendering of the frame ends at 614.

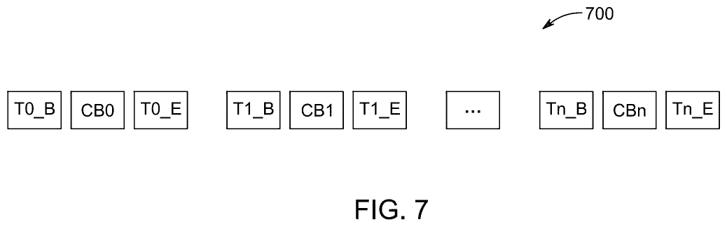

After rendering of the frame ends, GPU occupancy is calculated at 616, e.g., based on the timestamps written at 606 and 610. An example calculation is shown and described with respect to FIG. 7.

FIG. 7 is a block diagram 700 illustrating example command buffers and timestamp instructions for GPU occupancy calculation, e.g., as shown and described with respect to FIG. 6. In some implementations, command buffers are a list or other object which includes commands (e.g., rendering commands) to be submitted to a device (e.g., GPU) queue for execution. Command buffers are used in FIG. 7 as an example basis for determining GPU occupancy and/or idle time, however, it is noted that in some implementations, GPU occupancy is calculated based on other timing aspects and/or in a different way.

In the example of FIG. 7, a command buffer CB0 is prepared (e.g., the byte stream is written to memory), e.g., at 604, and a timestamp instruction T0_B is written at the beginning of CB0, which, when executed, will write an indication of the starting time of CB0 to memory, at 606. A timestamp instruction T0_E is written at the end of CB0, which, when executed, will write an indication of the ending time of CB0 to memory, at 610.

Similarly, command buffer CB1 is prepared (e.g., the byte stream is written to memory), e.g., at 604, and a timestamp instruction T1_B is written at the beginning of CB1, which, when executed, will write an indication of the starting time of CB1, at 606. A timestamp instruction T1_E is written at the end of CB1, which, when executed, will write an indication of the ending time of CB1, at 610. This process continues for a number (e.g., n) of further command buffers. Finally, command buffer CBn is prepared, e.g., at 604, and a timestamp instruction Tn_B is written at the beginning of CBn, which, when executed, will write an indication of the starting time of CBn, at 606. A timestamp instruction Tn_E is written at the end of CBn, which, when executed, will write an indication of the ending time of CBn, at 610.

In some implementations, GPU occupancy is calculated based on the timestamps for one or more of the command buffers. For example, in a case where it is desired to set a shading rate based on an average GPU occupancy and/or idle time over the execution of command buffers CB0-CBN, a total time (Tₜₒₜₐₗ), idle time (T_{idle}), and rendering time (T_{render}) are represented as follows:

$${T}_{t otal} = Tn\_E - T0\_B \qquad Eq . 1$$

$${T}_{i d l e} = ( T1\_B - T0\_E ) + ( T2\_B - T1\_E ) + … + ( T3\_B - T2\_E ) \qquad Eq . 2$$

$${T}_{r e n d e r} = ( T0\_E - T0\_B ) + ( T1\_E - T1\_B ) + … + ( Tn\_E - Tn\_B ) \qquad Eq . 3$$

Based on these times, GPU occupancy can be expressed as a percentage or ratio, either in terms of idle time or in terms of render time, as follows:

$$GPU occupancy = 1 - ( {T}_{i d l e} / {T}_{t otal} ) \qquad Eq . 4$$

$$GPU occupancy = ( {T}_{r e n d e r} / {T}_{t otal} ) \qquad Eq . 5$$

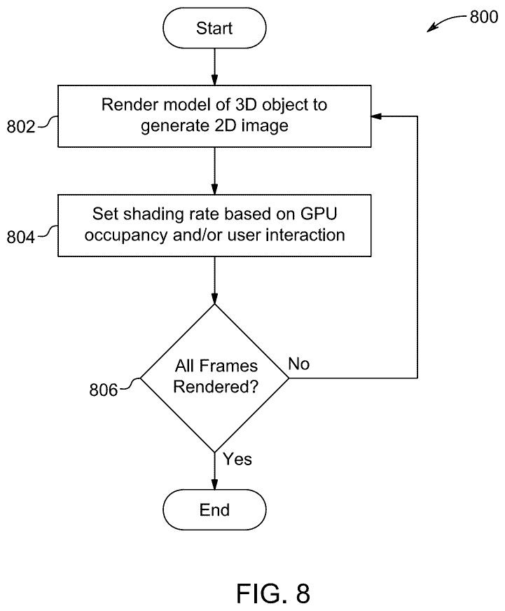

FIG. 8 is a block diagram illustrating an example method 800 for calculating a variable shading rate. At 802, a model of a 3D object is rendered, in a current frame, to generate a 2D image. In some implementations, the shading rate is a native shading rate. In some implementations, the shading rate is set based on rendering of a prior frame.

At 804, a shading rate is set based on the rendering of the current frame. In some implementations, the shading rate is set based on GPU occupancy and/or user interaction during rendering of the current frame. In some implementations, the shading rate is based on GPU occupancy and/or user interaction during rendering of an immediately preceding frame. In some implementations, GPU occupancy and user interaction comprise GPU occupancy and user interaction during rendering over a plurality of prior frames. In some implementations, GPU occupancy and user interaction comprise average GPU occupancy and user interaction during rendering over a plurality of prior frames.

In some implementations, the user interaction comprises rotating, panning, or zooming the 3D model or 2D image. In some implementations, the user interaction comprises a mouse manipulation or button press. In some implementations, GPU occupancy comprises occupancy of a GPU, occupancy of a GPU core, and/or occupancy of a plurality of GPUs or GPU cores. In some implementations, GPU occupancy comprises an idle time or a busy time of a GPU during rendering. In some implementations, GPU occupancy is calculated based on a start time of execution of a render command buffer and an end time of the execution of the render command buffer.

At 806, if all frames have not yet been rendered, the next frame is rendered at 802, based on the shading rate the current frame set at 804. Otherwise, the rendering ends.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, shaders, etc. may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering an image, the method comprising:
rendering, in a current frame, a model of a three-dimensional (3D) object to generate a two-dimensional (2D) image;
wherein a shading rate of the rendering is based on graphics processing unit (GPU) occupancy and user interaction, wherein the shading rate is reduced from a native shading rate in cases where both the user is interacting with the model and the GPU occupancy exceeds a threshold occupancy level and wherein the shading rate is the native shading rate otherwise.

2. The method of claim 1, wherein the GPU occupancy and user interaction comprise GPU occupancy and user interaction during rendering of a prior frame.

3. The method of claim 1, wherein the GPU occupancy and user interaction comprise GPU occupancy and user interaction during rendering of an immediately preceding frame.

4. The method of claim 1, wherein the GPU occupancy and user interaction comprise GPU occupancy and user interaction during rendering of a plurality of prior frames.

5. The method of claim 1, wherein the GPU occupancy and user interaction comprise average GPU occupancy and average user interaction over rendering of a plurality of prior frames.

6. The method of claim 1, wherein the user interaction comprises rotating, panning, or zooming the model or 2D image.

7. The method of claim 1, wherein the user interaction comprises a mouse manipulation or button press.

8. The method of claim 1, wherein the GPU occupancy comprises occupancy of a GPU, occupancy of a GPU core, and/or occupancy of a plurality of GPU cores.

9. The method of claim 1, wherein the GPU occupancy comprises an idle time or busy time of a GPU, during the rendering.

10. The method of claim 1, wherein the GPU occupancy is calculated based on a start time of execution of a render command buffer and an end time of the execution of the render command buffer.

11. A graphics processing unit (GPU) comprising:
circuitry configured to render, in a current frame, a model of a three-dimensional (3D) object to generate a two-dimensional (2D) image;
wherein a shading rate of the rendering is based on GPU occupancy and user interaction, wherein the shading rate is reduced from a native shading rate in cases where both the user is interacting with the model and the GPU occupancy exceeds a threshold occupancy level and wherein the shading rate is the native shading rate otherwise.

12. The GPU of claim 11, wherein the GPU occupancy and user interaction comprise GPU occupancy and user interaction during rendering of a prior frame.

13. The GPU of claim 11, wherein the GPU occupancy and user interaction comprise GPU occupancy and user interaction during rendering of an immediately preceding frame.

14. The GPU of claim 11, wherein the GPU occupancy and user interaction comprise GPU occupancy and user interaction during rendering of a plurality of prior frames.

15. The GPU of claim 11, wherein the GPU occupancy and user interaction comprise average GPU occupancy and average user interaction over rendering of a plurality of prior frames.

16. The GPU of claim 11, wherein the user interaction comprises rotating, panning, or zooming the model or 2D image.

17. The GPU of claim 11, wherein the user interaction comprises a mouse manipulation or button press.

18. The GPU of claim 11, wherein the GPU occupancy comprises occupancy of a graphics processing unit (GPU), occupancy of a plurality of GPUs, occupancy of a GPU core, and/or occupancy of a plurality of GPU cores.

19. The GPU of claim 11, wherein the GPU occupancy comprises an idle time or busy time of a processor, during the rendering.

20. The GPU of claim 11, wherein the GPU occupancy is calculated based on a start time of execution of a render command buffer and an end time of the execution of the render command buffer.
